(19) United States
(12) Patent Application Publication
(10) Pub. No.: US 2024/0089850 A1
(43) Pub. Date: Mar. 14, 2024

(54) CELL CONFIGURATION DETERMINATION METHOD AND APPARATUS, AND STORAGE MEDIUM

(71) Applicant: BEIJING XIAOMI MOBILE SOFTWARE CO., LTD., Beijing (CN)

(72) Inventor: Xing YANG, Beijing (CN)

(73) Assignee: BEIJING XIAOMI MOBILE SOFTWARE CO., LTD., Beijing (CN)

(21) Appl. No.: 18/272,345

(22) PCT Filed: Jan. 14, 2021
(86) PCT No.: PCT/CN2021/071789

§ 371 Date: Jul. 13, 2023

(51) Int. Cl. H04W 48/20; H04W 64/00

(52) U.S. Cl. CPC H04W 48/20; H04W 64/006; H04W 84/06

(57) ABSTRACT

The present disclosure provides a cell configuration determination method and apparatus, and a storage medium. The cell configuration determination method includes: receiving area information of at least one area covered by a cell; receiving cell configuration information corresponding to the area information; and on the basis of a position where a terminal is located, the area information of the at least one area, and the cell configuration information corresponding to the area information, determining a target area where the terminal is located and cell configuration information corresponding to the target area.

### CROSS-REFERENCE

The present application is a U.S. National Stage of International Application No. PCT/CN2021/071789, filed on Jan. 14, 2021, the contents of which are incorporated herein by reference in their entireties for all purposes.

### BACKGROUND

In a Non-Territorial Network (NTN), a base station antenna may be located on a high-altitude platform or a satellite, on a high altitude or in space which is tens of kilometers to tens of thousands of kilometers from the ground. Each NTN cell may cover a relatively large range, and can cover a range from tens of kilometers to hundreds of kilometers in diameter depending on a height of a transmitting antenna. The NTN is mainly used to cover a region without a territorial network, such as oceans, deserts, etc. Frequency authorizations in different countries or regions may be different, and users in the different regions need to comply with local regulations.

### SUMMARY

The present disclosure relates to the field of communications, and more particularly, to a method and apparatus for determining a cell configuration, and a storage medium.

According to a first aspect of the present disclosure, some embodiments provide a method for determining a cell configuration. The method is used for a terminal, and includes:
receiving area information of at least one area covered by a cell;
receiving cell configuration information corresponding to the area information; and
determining a target area where the terminal is located and target cell configuration information corresponding to the target area based on a position where the terminal is located, the area information of the at least one area, and the cell configuration information corresponding to the area information.

According to a second aspect of the present disclosure, some embodiments provide a method for determining a cell configuration. The method is used for a base station, and includes:
broadcasting area information of at least one area covered by a cell; and
broadcasting cell configuration information corresponding to the area information.

According to a third aspect of the present disclosure, some embodiments provide an apparatus for determining a cell configuration. The apparatus is used for a terminal, and includes:
a first receiving module, configured to receive area information of at least one area covered by a cell;
a second receiving module, configured to receive cell configuration information corresponding to the area information; and
a cell configuration information determining module, configured to determine a target area where the terminal is located and target cell configuration information corresponding to the target area based on a position where the terminal is located, the area information of the at least one area, and the cell configuration information corresponding to the area information.

According to a fourth aspect of the present disclosure, some embodiments provide an apparatus for determining a cell configuration. The apparatus is used for a base station, and includes:
a first broadcast module, configured to broadcast area information of at least one area covered by a cell; and
a second broadcast module, configured to broadcast cell configuration information corresponding to the area information.

According to a fifth aspect of the present disclosure, some embodiments provide a computer-readable storage medium having a computer program stored thereon, wherein the computer program is configured to execute any method for determining the cell configuration in the first aspect as described above.

According to a sixth aspect of the present disclosure, some embodiments provide a computer-readable storage medium having a computer program stored thereon, wherein the computer program is configured to execute any method for determining the cell configuration in the second aspect as described above.

According to a seventh aspect of the present disclosure, some embodiments provide an apparatus for determining a cell configuration, including:
a processor; and
a memory configured to store processor-executable instructions;
wherein the processor is configured to execute any method for determining the cell configuration in the first aspect as described above.

According to an eighth aspect of the present disclosure, some embodiments provide an apparatus for determining a cell configuration, including:
a processor; and
a memory configured to store processor-executable instructions;
wherein, the processor is configured to execute any method for determining the cell configuration in the second aspect as described above.

It should be noted that the above general description and the following detailed description are merely illustrative and explanatory and should not be construed as limiting of the disclosure.

### BRIEF DESCRIPTION OF THE DRAWINGS

The accompanying drawings here, which are incorporated in and constitute a part of the description, illustrate embodiments consistent with the present disclosure and, together with the description, serve to explain principles of the present disclosure.

FIG. 1 is a schematic flowchart showing a method for determining a cell configuration according to an embodiment of the present disclosure.

FIG. 2 is a schematic flowchart showing another method for determining a cell configuration according to an embodiment of the present disclosure.

FIG. 3 is a schematic flowchart showing another method for determining a cell configuration according to an embodiment of the present disclosure.

FIG. 4 is a schematic flowchart showing another method for determining a cell configuration according to an embodiment of the present disclosure.

FIG. 5 is a schematic flowchart showing another method for determining a cell configuration according to an embodiment of the present disclosure.

FIG. 6 is a schematic flowchart showing another method for determining a cell configuration according to an embodiment of the present disclosure.

FIG. 7 is a schematic flowchart showing another method for determining a cell configuration according to an embodiment of the present disclosure.

FIG. 8 is a schematic flowchart showing another method for determining a cell configuration according to an embodiment of the present disclosure.

FIG. 9 is a block diagram showing an apparatus for determining a cell configuration according to an embodiment of the present disclosure.

FIG. 10 is a block diagram showing another apparatus for determining a cell configuration according to an embodiment of the present disclosure.

FIG. 11 is a schematic structural diagram showing an electronic device according to an embodiment of the present disclosure.

FIG. 12 is a schematic structural diagram showing another apparatus for determining a cell configuration according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the present disclosure. Instead, they are merely examples of apparatuses and methods consistent with some aspects related to the present disclosure as recited in the appended claims.

The terms used in the present disclosure are merely for the purpose of describing particular embodiments and are not intended to limit the present disclosure. As used in the present disclosure and the appended claims, the singular forms “a”, “the” and “said” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “upon” or “when” or “in response to determination”.

In the following, a solution for determining a cell configuration provided by embodiments of the present disclosure will be introduced from a terminal side first.

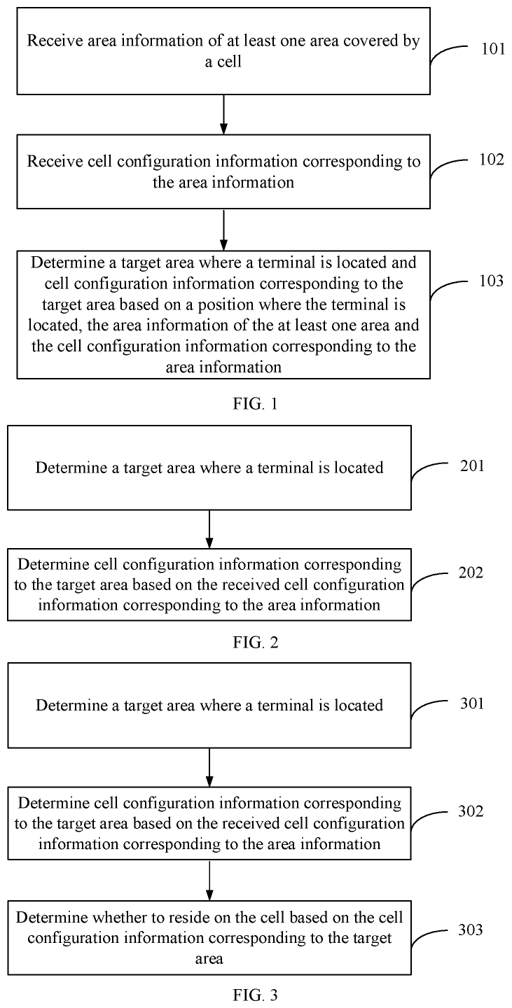

Referring to FIG. 1, which is a flowchart showing a method for determining a cell configuration according to an embodiment, the method can be used for a terminal and includes the following steps 101 to 103.

In the step 101, area information of at least one area covered by a cell is received.

In embodiments of the present disclosure, the terminal may receive a common signaling broadcast by a base station, so as to receive the area information of the at least one area covered by the cell. In an example, the common signaling may be a signaling for broadcasting a system message, and the system message includes the area information.

In the step 102, cell configuration information corresponding to the area information is received.

In embodiments of the present disclosure, the terminal may receive a common signaling broadcast by the base station, so as to receive the cell configuration information corresponding to the area information. In an example, the common signaling may be a signaling for broadcasting a system message, and the system message includes the cell configuration information. In embodiments of the present disclosure, the common signaling received by the terminal for broadcasting the area information may be the same as or different from the common signaling received by the terminal for broadcasting the cell configuration information, which is not limited by the present disclosure. On the basis of the same common signaling, the system message including the area information may be the same as or different from the system message including the cell configuration information, which is not limited by the present disclosure.

In embodiments of the present disclosure, the area information of the at least one area and the cell configuration information may be received together or separately, which is not limited by the embodiments of the present disclosure. For example, in a case where the broadcast area information and cell configuration information received by the terminal are carried in the same common signaling, the step 101 and the step 102 may be combined.

In an example, each piece of area information may correspond to one piece of cell configuration information. In another example, each piece of area information may correspond to two or more pieces of cell configuration information. In still another example, two or more pieces of area information may correspond to one piece of cell configuration information. The present disclosure does not limit this.

In the step 103, a target area where the terminal is located and cell configuration information corresponding to the target area are determined based on a position where the terminal is located, the area information of the at least one area and the cell configuration information corresponding to the area information.

In the above embodiments, the terminal may determine the target area where it is located and the cell configuration information corresponding to the target area based on the position where it is located, the received area information of the at least one area, and the received cell configuration information corresponding to the area information. The present disclosure enables the terminal to determine the more matched cell configuration information, and achieves the high availability.

In some embodiments of the present disclosure, referring to FIG. 2, which is a flowchart showing a method for determining a cell configuration according to an embodiment, the method includes the following steps 201 to 202.

In the step 201, a target area where the terminal is located is determined.

In embodiments of the present disclosure, there may be many ways to determine the target area where the terminal is located. For example, as described in the foregoing embodiments, the target area where the terminal is located is determined through the position where the terminal is located and the received area identity of the at least one area. In embodiments of the present disclosure, the terminal can determine the position where it is located through, but not limited to, a Global Positioning System (GPS), base station positioning, WiFi positioning and other manners, and the position where the terminal is located includes, but is not limited to, a geographic position indicated by latitude and longitude, a country to which the position where the terminal is located belongs, an area of the country to which the position where the terminal is located belongs, etc. Therefore, the target area where the terminal is located is determined based on the position where the terminal is located and the received area information of the at least one area covered by the cell. In embodiments of the present disclosure, the involved cell may include, but is not limited to, a NTN cell.

For example, the country to which the position where the terminal is located belongs is China, the received area information includes China, Vietnam, and Laos, and the terminal determines that the target area corresponding to the position where the terminal is located is China.

In the step 202, cell configuration information corresponding to the target area is determined based on the received cell configuration information corresponding to the area information.

For example, the cell configuration information received by the terminal includes cell configuration information 1 corresponding to China, cell configuration information 2 corresponding to Vietnam, and cell configuration information 3 corresponding to Laos. The target area where the terminal is located is China, and then the cell configuration information 1 can be used as the cell configuration information corresponding to the target area. In the above embodiments, the terminal can determine the target area where it is located according to the position where it is located and the received area identity of the at least one area, and further determine the cell configuration information corresponding to the target area, which is simple to implement and achieves the high availability.

In some embodiments of the present disclosure, referring to FIG. 3, which is a flowchart showing a method for determining a cell configuration according to an embodiment, the method includes the following steps 301 to 303.

In the step 301, a target area where the terminal is located is determined.

In embodiments of the present disclosure, there may be many ways to determine the target area where the terminal is located. For example, as described in the foregoing embodiments, the target area where the terminal is located is determined through the position where the terminal is located and the received area identity of the at least one area. In embodiments of the present disclosure, the terminal can determine the position where it is located through, but not limited to, a GPS, base station positioning, WiFi positioning and other manners, and the position where the terminal is located includes, but is not limited to, a geographic position indicated by latitude and longitude, a country to which the position where the terminal is located belongs, an area of the country to which the position where the terminal is located belongs, etc. Therefore, the target area where the terminal is located is determined based on the position where the terminal is located and the received area information of the at least one area covered by the cell.

In the step 302, cell configuration information corresponding to the target area is determined based on the received cell configuration information corresponding to the area information.

In the step 303, it is determined whether to reside on the cell based on the cell configuration information corresponding to the target area.

In embodiments of the present disclosure, the cell configuration information may be used to indicate whether the terminal is allowed to reside. In an example, the cell configuration information directly indicates whether the terminal is allowed to reside, including, but not limited to, the cell configuration information including information content indicating whether the terminal is allowed to reside, or the cell configuration information includes a target information element, where the target information element is set to a first preset value to indicate that the terminal is allowed to reside, and the target information element is set to a second preset value to indicate that the terminal is not allowed to reside. Then in the step 303, the terminal may directly determine whether to reside on the cell according to the indication of the cell configuration information corresponding to the target area.

For example, the target information element in the cell configuration information corresponding to the target area is set to the first preset value, which is assumed to be “true”, then the terminal determines to reside on the cell, and the target information element in the cell configuration information corresponding to the target area is set to the second preset value, which is assumed to be “false”, then the terminal determines not to reside on the cell.

The above is only an illustrative description, and other implementations of directly indicating whether the terminal is allowed to reside through the cell configuration information shall fall within the protection scope of the present disclosure.

In the above embodiments, the terminal can directly determine whether to reside on the cell based on the cell configuration information corresponding to the target area, so as to prevent the terminal from residing on the cell that is not allowed by regulations, which achieves the high availability.

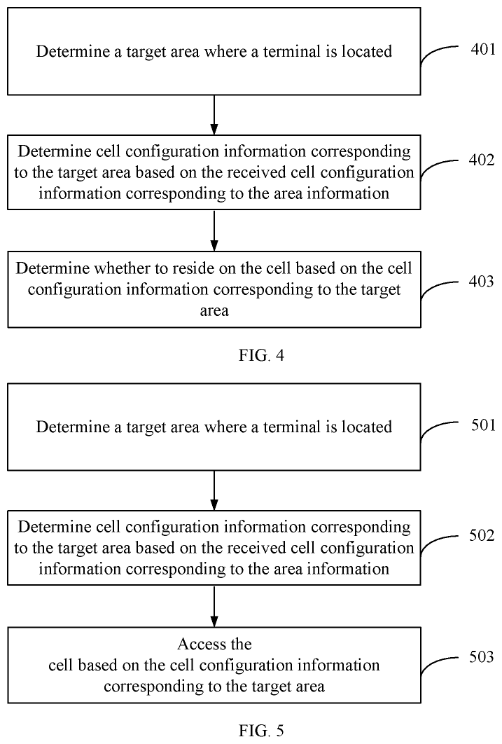

In some embodiments of the present disclosure, referring to FIG. 4, which is a flowchart showing a method for determining a cell configuration according to an embodiment, the method includes the following steps 401 to 403.

In the step 401, a target area where the terminal is located is determined.

In embodiments of the present disclosure, there may be many ways to determine the target area where the terminal is located. For example, as described in the foregoing embodiments, the target area where the terminal is located is determined through the position where the terminal is located and the received area identity of the at least one area. In embodiments of the present disclosure, the terminal can determine the position where it is located through, but not limited to, a GPS, and the position where the terminal is located includes, but is not limited to, a geographic position indicated by latitude and longitude, a country to which the position where the terminal is located belongs, an area of the country to which the position where the terminal is located belongs, etc. Therefore, the target area where the terminal is located is determined based on the position where the terminal is located and the received area information of the at least one area covered by the cell.

In the step 402, cell configuration information corresponding to the target area is determined based on the received cell configuration information corresponding to the area information.

In the step 403, it is determined whether to reside on the cell based on the cell configuration information corresponding to the target area.

In embodiments of the present disclosure, the cell configuration information may be used to indicate whether the terminal is allowed to reside. In an example, the cell configuration information does not directly indicate whether the terminal is allowed to reside, then in the step 403, the terminal may determine whether to reside on the cell based on a protocol agreement and the cell configuration information corresponding to the target area.

In some embodiments of the present disclosure, the cell configuration information includes at least one bit value indicating whether the terminal is allowed to reside, and the terminal may determine content correspondingly indicated by the at least one bit value based on the protocol agreement.

The above is only an illustrative description, and other implementations of implicitly indicating whether the terminal is allowed to reside in the cell configuration information shall fall within the protection scope of the present disclosure.

For example, cell configuration information 1 includes a bit value of 1, cell configuration information 2 includes a bit value of 0, and cell configuration information 3 includes a bit value of 1. The terminal determines that the cell configuration information corresponding to the target area is the cell configuration information 1, and based on the protocol agreement, the terminal determines that the bit value of 1 included in cell configuration information 1 correspondingly indicates that the terminal is allowed to reside, then the terminal determines to reside on the cell. If the cell configuration information corresponding to the target area is the cell configuration information 2, the terminal determines that the bit value of 0 included in the cell configuration information 2 correspondingly indicates that the terminal is not allowed to reside based on the protocol agreement, then the terminal determines not to reside on the cell.

The above is only an illustrative description, and other implementations of determining whether to reside on the cell based on the cell configuration information corresponding to the area information should fall within the protection scope of the present disclosure.

In the above embodiments, the terminal can determine whether to reside on the cell based on the cell configuration information and the protocol agreement, so as to prevent the terminal from residing on the cell that is not allowed by the regulations, which achieves the high availability.

In some embodiments of the present disclosure, referring to FIG. 5, which is a flowchart showing a method for determining a cell configuration according to an embodiment, the method includes the following steps 501 to 503.

In the step 501, a target area where the terminal is located is determined.

In embodiments of the present disclosure, there may be many ways to determine the target area where the terminal is located. For example, as described in the foregoing embodiments, the target area where the terminal is located is determined through the position where the terminal is located and the received area identity of the at least one area. In embodiments of the present disclosure, the terminal can determine the position where it is located through, but not limited to, a GPS, base station positioning, WiFi positioning, and other manners, and the position where the terminal is located includes, but is not limited to, a geographic position indicated by latitude and longitude, a country to which the position where the terminal is located belongs, an area of the country to which the position where the terminal is located belongs, etc. Therefore, the target area where the terminal is located is determined based on the position where the terminal is located and the received area information of the at least one area covered by the cell.

In the step 502, cell configuration information corresponding to the target area is determined based on the received cell configuration information corresponding to the area information.

In the step 503, the cell is accessed based on the cell configuration information corresponding to the target area.

In embodiments of the present disclosure, the cell configuration information may include at least one of the following: a cell access control parameter and a cell selection parameter. The terminal may access the cell based on the above parameter included in the determined cell configuration information corresponding to the target area.

In an example, after determining that the cell can be accessed based on the at least one of the cell access control parameter and the cell selection parameter included in the cell configuration information corresponding to the target area, the terminal accesses the cell based on the at least one of the above parameters.

In an example, the terminal directly accesses the cell based on the at least one of the cell access control parameter and the cell selection parameter included in the cell configuration information corresponding to the target area.

The above is only an illustrative description, and other implementations of performing cell access based on the cell configuration information corresponding to the area information shall fall within the protection scope of the present disclosure.

In the above embodiments, the terminal can access the cell based on the cell configuration information corresponding to the target area matching the position where the terminal is located, which improves the success rate of cell access, is simple to implement and achieves the high availability.

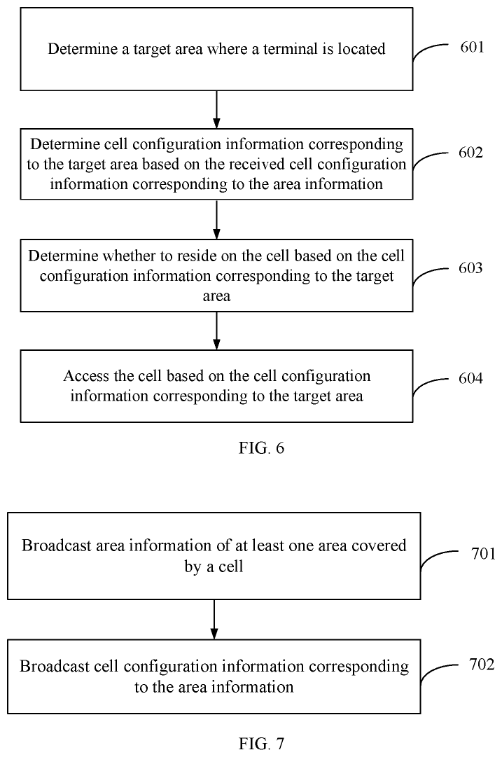

In some embodiments of the present disclosure, referring to FIG. 6, which is a flowchart showing a method for determining a cell configuration according to an embodiment, the method includes the following steps 601 to 604.

In the step 601, a target area where the terminal is located is determined.

In embodiments of the present disclosure, there may be many ways to determine the target area where the terminal is located. For example, as described in the foregoing embodiments, the target area where the terminal is located is determined through the position where the terminal is located and the received area identity of the at least one area. In embodiments of the present disclosure, the terminal can determine the position where it is located through, but not limited to, a GPS, base station positioning, WiFi positioning and other manners, and the position where the terminal is located includes, but is not limited to, a geographic position indicated by latitude and longitude, a country to which the position where the terminal is located belongs, an area of the country to which the position where the terminal is located belongs, etc. Therefore, the target area where the terminal is located is determined based on the position where the terminal is located and the received area information of the at least one area covered by the cell.

In the step 602, cell configuration information corresponding to the target area is determined based on the received cell configuration information corresponding to the area information.

In the step 603, it is determined whether to reside on the cell based on the cell configuration information corresponding to the target area.

In embodiments of the present disclosure, the cell configuration information is used to indicate whether the terminal is allowed to reside. The cell configuration information may directly indicate whether the terminal is allowed to reside, and correspondingly, the terminal can directly determine whether to reside on the cell according to the indication of the cell configuration information corresponding to the target area.

Alternatively, whether the terminal is allowed to reside is implicitly indicated in the cell configuration information, and the terminal can determine whether to reside on the cell according to a protocol agreement and the cell configuration information corresponding to the target area.

In the step 604, the cell is accessed based on the cell configuration information corresponding to the target area.

In embodiments of the present disclosure, the cell configuration information may include at least one of the following: a cell access control parameter and a cell selection parameter. The terminal may access the cell based on the cell configuration information corresponding to the target area in the case of determining to reside on the cell.

For example, the cell configuration information corresponding to the target area includes an access control parameter A, and the terminal accesses the cell based on the access control parameter A.

The above is only an illustrative description, and other implementations of determining whether to reside on the cell and/or access the cell based on the cell configuration information corresponding to the area information shall fall within the protection scope of the present disclosure.

In the above embodiments, the terminal may determine whether to reside on the cell according to the cell configuration information corresponding to the target area, and may further access the cell based on the cell configuration information corresponding to the target area in the case of determining to reside on the cell, which can improve the success rate of cell access while avoiding access to the cell that is not allowed by the regulations.

In some embodiments of the present disclosure, the area information received by the terminal may include, but is not limited to, at least one of the following: a plurality of pieces of coordinate position information for determining a covered area, an identity of a country where the cell is located, and an area identity of the covered area.

In an example, the terminal may determine an area range formed by lines between a plurality of coordinate positions according to the plurality of pieces of coordinate position information. In an example, the terminal may determine a country corresponding to the cell according to the identity of the country where the cell is located. In an example, the terminal may directly determine a corresponding area according to the area identity of the covered area. For example, geographic positions can be directly divided in a standard, and corresponding area identities are specified.

The above is only an illustrative description, and other content belonging to the area information shall fall within the protection scope of the present disclosure.

In the above embodiments, the terminal determines an area range of the at least one area covered by the cell according to the received area information, so as to subsequently determine the target area where it is located based on the position where it is located and the area information, which is simple to implement and achieves the high availability.

A solution for determining a cell configuration provided by embodiments of the present disclosure will also be introduced from a base station side below.

Referring to FIG. 7, which is a flowchart showing a method for determining a cell configuration according to an embodiment, the method can be used for a base station, and includes the following steps 701 to 702.

In the step 701, area information of at least one area covered by a cell is broadcast.

In embodiments of the present disclosure, the base station may broadcast the area information through a common signaling. The cell includes, but is not limited to, a NTN cell, and the common signaling includes, but is not limited to, a signaling for broadcasting a system message, and the system message includes the area information.

In the step 702, cell configuration information corresponding to the area information is broadcast.

In embodiments of the present disclosure, the base station may broadcast the cell configuration information corresponding to the area information through a common signaling, and the common signaling includes, but is not limited to, a signaling for broadcasting a system message, and the system message includes the cell configuration information.

In embodiments of the present disclosure, the area information of the at least one area and the cell configuration information may be received together or separately, which is not limited by the embodiments of the present disclosure. For example, in a case where the broadcast area information and cell configuration information received by the terminal are carried in the same common signaling, the step 701 and the step 702 may be combined.

On the basis of the same common signaling, the system message including the area information may be the same as or different from the system message including the cell configuration information, which is not limited by the present disclosure.

In the above embodiments, the base station may broadcast the area information of the at least one area covered by the cell, and may also broadcast the cell configuration information corresponding to the area information. A terminal side may determine the target area where it is located and the cell configuration information corresponding to the target area based on the position where it is located, the received area information of the at least one area and the received cell configuration information corresponding to the area information. The present disclosure enables the terminal to determine the more matched cell configuration information, and achieves the high availability.

In some embodiments of the present disclosure, the cell configuration information broadcast by the base station may be used to indicate whether the terminal is allowed to reside.

In a possible example, the cell configuration information directly indicates whether the terminal is allowed to reside, including, but not limited to, the cell configuration information including information content indicating whether the terminal is allowed to reside, or the cell configuration information includes a target information element, where the target information element is set to a first preset value to indicate that the terminal is allowed to reside, and the target information element is set to a second preset value to indicate that the terminal is not allowed to reside. The first preset value may include, but is not limited to, “true”, and the second preset value may include, but is not limited to, “false”.

The above is only an illustrative description, and other implementations of directly indicating whether the terminal is allowed to reside through the cell configuration information shall fall within the protection scope of the present disclosure.

In a possible example, the cell configuration information does not directly indicate whether the terminal is allowed to reside, that is, the cell configuration information implicitly indicates whether the terminal is allowed to reside. In an example, the cell configuration information may indicate whether the terminal is allowed to reside through at least one bit. For example, a bit value of a specified bit in the cell configuration information is set to 1, which is used to implicitly indicate that the terminal is allowed to reside, and the bit value of the specified bit is set to 0, which is used to implicitly indicate that the terminal is not allowed to reside.

The above is only an illustrative description, and other implementations of implicitly indicating whether the terminal is allowed to reside through the cell configuration information shall fall within the protection scope of the present disclosure.

In some embodiments of the present disclosure, the cell configuration information may include at least one of the following: a cell access control parameter and a cell selection parameter. Based on the above parameter, the terminal side is enabled to complete the cell access more quickly.

In some embodiments of the present disclosure, the cell configuration information may be used to indicate whether the terminal is allowed to reside, and includes at least one of the following: the cell access control parameter and the cell selection parameter.

In some embodiments of the present disclosure, the area information broadcast by the base station may include, but is not limited to, at least one of the following: a plurality of pieces of coordinate position information for determining a covered area, an identity of a country where the cell is located, and an area identity of the covered area.

The plurality of pieces of coordinate position information is used to locate a current area, and an area formed by lines between a plurality of coordinate positions is an area corresponding to the area information. The identity of the covered area includes, but is not limited to, an area identity obtained by dividing the geographical positions.

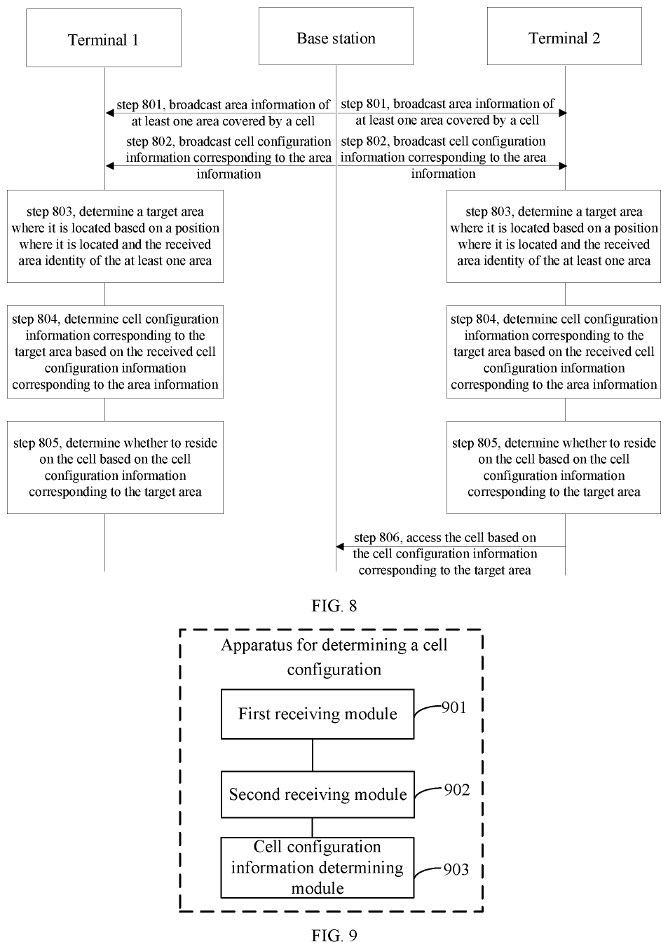

In some embodiments of the present disclosure, referring to FIG. 8, which is a flowchart showing a method for determining a cell configuration according to an embodiment, the method includes the following steps 801 to 806.

In the step 801, the base station broadcasts area information of at least one area covered by a cell.

In embodiments of the present disclosure, the base station may broadcast the area information through a common signaling.

In the step 802, the base station broadcasts cell configuration information corresponding to the area information.

In embodiments of the present disclosure, the base station may broadcast the cell configuration information corresponding to the area information through a common signaling.

In the step 803, the terminal determines a target area where it is located based on a position where it is located and the received area identity of the at least one area.

In the step 804, the terminal determines cell configuration information corresponding to the target area based on the received cell configuration information corresponding to the area information.

In the step 805, the terminal determines whether to reside on the cell based on the cell configuration information corresponding to the target area.

The preceding steps 803 to 805 are executed in the same manner on terminal sides in FIG. 8.

In the step 806, the terminal accesses the cell based on the cell configuration information corresponding to the target area.

In FIG. 8, terminal 1 determines not to reside on the cell, and then terminal 1 does not need to perform the step 806. Terminal 2 determines to reside on the cell, and terminal 2 performs the step 806 to access the cell.

The above embodiments are further exemplified as follows.

For example, area information covered by a certain NTN cell and cell configuration information corresponding to the area information which are broadcast by the base station include: area information 1 is China, and the corresponding cell configuration information 1 indicates that the terminal is not allowed to reside; area information 2 is Vietnam, the corresponding cell configuration information 2 indicates that the terminal is allowed to reside, and an access control parameter is A; and area information 3 is Laos, the corresponding cell configuration information 3 indicates that the terminal is allowed to reside, and the access control parameter is B.

After receiving the area information and the corresponding cell configuration information, the terminal 1 determines that its position is China, and then the target area is China. The terminal 1 determines that the cell configuration information corresponding to the target area is the cell configuration information 1, and the terminal 1 determines not to reside on the cell based on the cell configuration information 1.

After receiving the area information and the corresponding cell configuration information, the terminal 2 determines that its position is Laos and then the target area is Laos. Then the terminal 2 determines that the cell configuration information corresponding to the target area is the cell configuration information 2, determines to reside on the cell based on the cell configuration information 2, and further access the cell based on the access control parameter A.

In the above embodiments, the terminal is enabled to determine the more matched cell configuration information, preventing the terminal from residing on the cell that is not allowed by the regulations, and improving the success rate of cell access.

Corresponding to the foregoing embodiments of the method for implementing application functions, the present disclosure also provides embodiments of an apparatus for implementing the application functions.

Referring to FIG. 9, which is a block diagram showing an apparatus for determining a cell configuration according to an embodiment, the apparatus is used for a terminal and includes:
a first receiving module 901, configured to receive area information of at least one area covered by a cell;
a second receiving module 902, configured to receive cell configuration information corresponding to the area information; and
a cell configuration information determining module 903, configured to determine a target area where the terminal is located and cell configuration information corresponding to the target area based on a position where the terminal is located, the area information of the at least one area and the cell configuration information corresponding to the area information.

In embodiments of the present disclosure, the first receiving module 901 and the second receiving module 902 may be the same or different modules, which are not limited by the present disclosure.

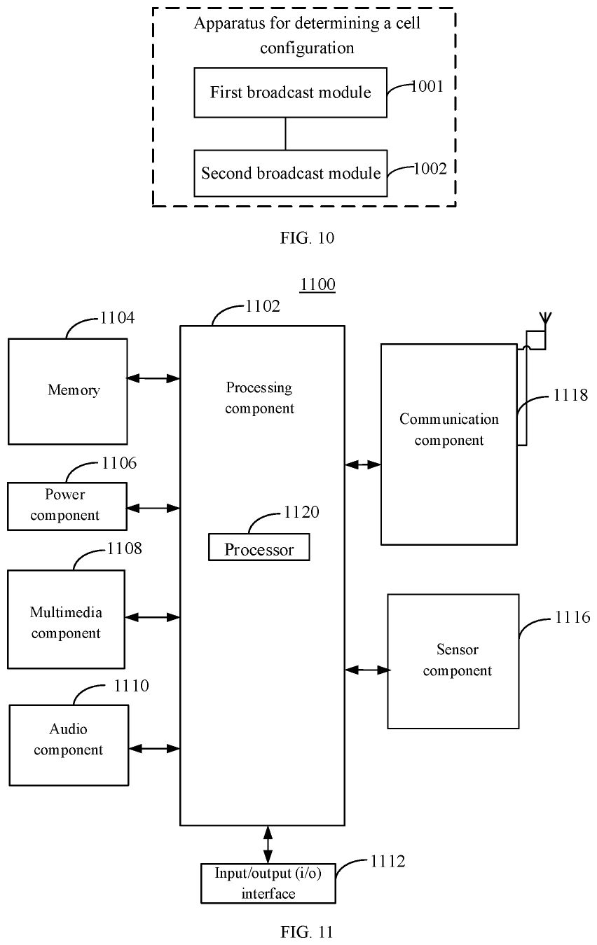

Referring to FIG. 10, which is a block diagram showing an apparatus for determining a cell configuration according to an embodiment, the apparatus is used for a base station and includes:
a first broadcast module 1001, configured to broadcast area information of at least one area covered by a cell; and
a second broadcast module 1002, configured to broadcast cell configuration information corresponding to the area information.

In embodiments of the present disclosure, the first broadcast module 1001 and the second broadcast module 1002 may be the same or different modules, which are not limited by the present disclosure.

For the apparatus embodiments, since they basically correspond to the method embodiments, the relevant parts can be referred to the description of the method embodiments. The apparatus embodiments described above are only illustrative. The units described as separate parts may or may not be physically separated, and the parts shown as units may or may not be physical units, that is, the units may be located in one place, or may be distributed over a plurality of network units. Some or all of the modules may be selected according to actual needs to achieve the objectives of the solutions of the present disclosure. Those ordinary skilled in the art can understand and implement the present disclosure without paying creative labor.

Correspondingly, the present disclosure also provides a computer-readable storage medium having a computer program stored thereon, and the computer program is configured to execute any method for determining the cell configuration on the terminal side as described above.

Correspondingly, the present disclosure also provides a computer-readable storage medium having a computer program stored thereon, and the computer program is configured to execute any method for determining the cell configuration on the base station side as described above.

Correspondingly, the present disclosure also provides an apparatus for determining a cell configuration, including:
a processor; and
a memory configured to store processor-executable instructions;
the processor is configured to execute any method for determining the cell configuration on the terminal side.

FIG. 11 is a block diagram showing an electronic device 1100 according to an embodiment. For example, the electronic device 1100 may be a terminal such as a mobile phone, a tablet computer, an e-book reader, a multimedia playback device, a wearable device, a vehicle terminal, an ipad, or a smart TV.

Referring to FIG. 11, the electronic device 1100 may include one or more of the following components: a processing component 1102, a memory 1104, a power component 1106, a multimedia component 1108, an audio component 1110, an input/output (I/O) interface 1112, a sensor component 1116 and a communication component 1118.

The processing component 1102 typically controls overall operations of the electronic device 1100, such as the operations associated with display, telephone calls, data communications, camera operations, and recording operations. The processing component 1102 may include one or more processors 1120 to execute instructions to perform all or part of the steps in the method for determining the cell configuration described above. Moreover, the processing component 1102 may include one or more modules that facilitate the interaction between the processing component 1102 and other components. For instance, the processing component 1102 may include a multimedia module to facilitate the interaction between the multimedia component 1108 and the processing component 1102. In another example, the processing component 1102 may read executable instructions from the memory, so as to implement steps of the method for determining the cell configuration provided by the above various embodiments.

The memory 1104 is configured to store various types of data to support the operation of the electronic device 1100. Examples of such data include instructions for any application or method operated on the electronic device 1100, contact data, phonebook data, messages, pictures, video, etc. The memory 1104 may be implemented using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 1106 provides power to various components of the electronic device 1100. The power component 1106 may include a power management system, one or more power sources, and any other components associated with the generation, management, and distribution of power in the electronic device 1100.

The multimedia component 1108 includes a display screen providing an output interface between the electronic device 1100 and the user. In some embodiments, the multimedia component 1108 includes a front camera and/or a rear camera. The front camera and/or the rear camera may receive an external multimedia datum while the electronic device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (“MIC”) configured to receive an external audio signal when the electronic device 1100 is in an operation mode, such as a call mode, a recording mode, and a voice recognition mode. The received audio signal may be further stored in the memory 1104 or transmitted via the communication component 1118. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1116 includes one or more sensors to provide status assessments of various aspects of the electronic device 1100. For instance, the sensor component 1116 may detect an open/closed status of the electronic device 1100, relative positioning of components, e.g., the display and the keypad, of the electronic device 1100, a change in position of the electronic device 1100 or a component of the electronic device 1100, a presence or absence of the user contact with the electronic device 1100, an orientation or an acceleration/deceleration of the electronic device 1100, and a change in temperature of the electronic device 1100. The sensor component 1116 may include a proximity sensor configured to detect the presence of nearby objects without any physical contact. The sensor component 1116 may also include a light sensor, such as a CMOS or CCD image sensor, for use in imaging applications. In some embodiments, the sensor component 1116 may also include an accelerometer sensor, a gyroscope sensor, a magnetic sensor, a pressure sensor, or a temperature sensor.

The communication component 1118 is configured to facilitate communication, wired or wirelessly, between the electronic device 1100 and other devices. The electronic device 1100 can access a wireless network based on a communication standard, such as WiFi, 2G, 3G, 4G, 5G or 6G, or a combination thereof. In an example embodiment, the communication component 1118 receives a broadcast signal or broadcast associated information from an external broadcast management system via a broadcast channel. In an example embodiment, the communication component 1118 further includes a Near Field Communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

In embodiments of the present disclosure, the electronic device 1100 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors, or other electronic components, for performing the method for determining the cell configuration as described above.

In embodiments of the present disclosure, there is also provided a non-transitory machine readable storage medium including instructions, such as included in the memory 1104, executable by the processor 1120 in the electronic device 1100, for performing the method for determining the cell configuration as described above. For example, the non-transitory computer readable storage medium may be a ROM, a RAM, a CD-ROM, a magnetic tape, a floppy disc, an optical data storage device, and the like.

Correspondingly, the present disclosure also provides an apparatus for determining a cell configuration, including:
a processor; and
a memory configured to store processor-executable instructions;
the processor is configured to execute any method for determining the cell configuration on the base station side.

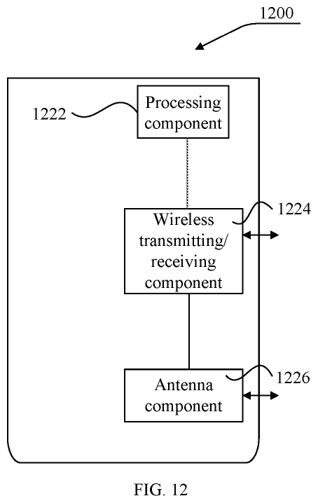

As shown in FIG. 12, which is a schematic structural diagram showing another apparatus 1200 for determining a cell configuration according to embodiment, the apparatus 1200 may be provided as a base station. Referring to FIG. 12, the apparatus 1200 includes a processing component 1222, a wireless transmitting/receiving component 1224, an antenna component 1226, and a signal processing part specific to a wireless interface. The processing component 1222 may further include one or more processors.

One of the processors in the processing component 1222 can be configured to perform any method for determining the cell configuration on the base station side as described above.

Embodiments of the present disclosure provide a method and apparatus for determining a cell configuration, and a storage medium.

According to a first aspect of embodiments of the present disclosure, there is provided a method for determining a cell configuration. The method is used for a terminal, and includes:
receiving area information of at least one area covered by a cell;
receiving cell configuration information corresponding to the area information; and
determining a target area where the terminal is located and cell configuration information corresponding to the target area based on a position where the terminal is located, the area information of the at least one area and the cell configuration information corresponding to the area information.

In some embodiments of the present disclosure, the determining the target area where the terminal is located and the cell configuration information corresponding to the target area based on the position where the terminal is located, the area information of the at least one area and the cell configuration information corresponding to the area information includes:
determining the target area where the terminal is located based on the position where the terminal is located and the area information of the at least one area; and
determining the cell configuration information corresponding to the target area based on the cell configuration information corresponding to the area information.

In some embodiments of the present disclosure, the cell configuration information is used to indicate whether the terminal is allowed to reside.

In some embodiments of the present disclosure, the method further includes:
determining whether to reside on the cell based on indication of the cell configuration information corresponding to the target area; or
determining whether to reside on the cell based on the cell configuration information corresponding to the target area and a protocol agreement.

In some embodiments of the present disclosure, the cell configuration information includes at least one of the following: a cell access control parameter and a cell selection parameter.

In some embodiments of the present disclosure, the method includes:
accessing the cell based on the cell configuration information corresponding to the target area.

In some embodiments of the present disclosure, the area information includes at least one of the following:
a plurality of pieces of coordinate position information for determining a covered area, an identity of a country where the cell is located, and an area identity of the covered area.

According to a second aspect of embodiments of the present disclosure, there is provided a method for determining a cell configuration. The method is used for a base station, and includes:
broadcasting area information of at least one area covered by a cell; and
broadcasting cell configuration information corresponding to the area information.

In some embodiments of the present disclosure, the cell configuration information is used to indicate whether a terminal is allowed to reside.

In some embodiments of the present disclosure, the cell configuration information includes at least one of the following: a cell access control parameter and a cell selection parameter.

In some embodiments of the present disclosure, the area information includes at least one of the following:
a plurality of pieces of coordinate position information for determining a covered area, an identity of a country where the cell is located, and an area identity of the covered area.

According to a third aspect of embodiments of the present disclosure, there is provided an apparatus for determining a cell configuration. The apparatus is used for a terminal, and includes:
a first receiving module, configured to receive area information of at least one area covered by a cell;
a second receiving module, configured to receive cell configuration information corresponding to the area information; and
a cell configuration information determining module, configured to determine a target area where the terminal is located and cell configuration information corresponding to the target area based on a position where the terminal is located, the area information of the at least one area and the cell configuration information corresponding to the area information.

According to a fourth aspect of embodiments of the present disclosure, there is provided an apparatus for determining a cell configuration. The apparatus is used for a base station, and includes:
a first broadcast module, configured to broadcast area information of at least one area covered by a cell; and
a second broadcast module, configured to broadcast cell configuration information corresponding to the area information.

According to a fifth aspect of embodiments of the present disclosure, there is provided a computer-readable storage medium having a computer program stored thereon, wherein the computer program is configured to execute any method for determining the cell configuration in the first aspect as described above.

According to a sixth aspect of embodiments of the present disclosure, there is provided a computer-readable storage medium having a computer program stored thereon, wherein the computer program is configured to execute any method for determining the cell configuration in the second aspect as described above.

According to a seventh aspect of embodiments of the present disclosure, there is provided an apparatus for determining a cell configuration, including:
a processor; and
a memory configured to store processor-executable instructions;
wherein the processor is configured to execute any method for determining the cell configuration in the first aspect as described above.

According to an eighth aspect of embodiments of the present disclosure, there is provided an apparatus for determining a cell configuration, including:
a processor; and
a memory configured to store processor-executable instructions;
wherein, the processor is configured to execute any method for determining the cell configuration in the second aspect as described above.

The technical solutions provided by the embodiments of the present disclosure may include the following beneficial effects:
in the embodiments of the present disclosure, the terminal may determine the target area where it is located and the cell configuration information corresponding to the target area based on the position where it is located, the received area information of the at least one area and the received cell configuration information corresponding to the area information. The present disclosure enables the terminal to determine the more matched cell configuration information, and achieves the high availability.

In the embodiments of the present disclosure, the cell configuration information received by the terminal may be used to indicate whether the terminal is allowed to reside, so that the terminal can be prevented from residing on the cell that is not allowed by regulations, which achieves the high availability.

In the embodiments of the present disclosure, the terminal may directly determine whether to reside on the cell based on the indication of the cell configuration information corresponding to the target area; alternatively, the terminal determines whether to reside on the cell based on the protocol agreement and the cell configuration information corresponding to the target area, which is simple to implement and achieves the high availability.

In the embodiments of the present disclosure, the terminal may perform cell access based on the cell configuration information corresponding to the target area. The disclosure can enable the terminal to select a more suitable cell for access, which achieves the high availability.

Other embodiments of the present disclosure will be apparent to those skilled in the art from consideration of the specification and practice of the present disclosure disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

It should be understood that the present disclosure is not limited to the precise structures that have been described above and shown in the drawings, and various modifications and changes can be made without departing from the scope thereof. The scope of the present disclosure is limited only by the appended claims.

1. A method for determining a cell configuration, wherein the method is used for a terminal and comprises:
receiving area information of at least one area covered by a cell;
receiving cell configuration information corresponding to the area information; and
determining a target area where the terminal is located and target cell configuration information corresponding to the target area based on a position where the terminal is located, the area information of the at least one area and the cell configuration information corresponding to the area information.

2. The method according to claim 1, wherein determining the target area where the terminal is located and the target cell configuration information corresponding to the target area based on the position where the terminal is located, the area information of the at least one area and the cell configuration information corresponding to the area information comprises:
determining the target area where the terminal is located based on the position where the terminal is located and the area information of the at least one area; and
determining the target cell configuration information corresponding to the target area based on the cell configuration information corresponding to the area information.

3. The method according to claim 2, wherein the target cell configuration information is used to indicate whether the terminal is allowed to reside on the cell.

4. The method according to claim 3, further comprising:
determining whether to reside on the cell based on indication of the target cell configuration information corresponding to the target area; or
determining whether to reside on the cell based on the target cell configuration information corresponding to the target area and a protocol agreement.

5. The method according to claim 1, wherein the target cell configuration information comprises at least one of: a cell access control parameter and a cell selection parameter.

6. The method according to claim 5, further comprising:
accessing the cell based on the target cell configuration information corresponding to the target area.

7. The method according to claim 1, wherein the area information comprises at least one of:
a plurality of pieces of coordinate position information for determining a covered area, an identity of a country where the cell is located, and an area identity of the covered area.

8. A method for determining a cell configuration, wherein the method is used for a base station and comprises:
broadcasting area information of at least one area covered by a cell; and
broadcasting cell configuration information corresponding to the area information.

9. The method according to claim 8, wherein the cell configuration information is used to indicate whether a terminal is allowed to reside on the cell.

10. The method according to claim 8, wherein the cell configuration information comprises at least one of: a cell access control parameter and a cell selection parameter.

11. The method according to claim 8, wherein the area information comprises at least one of:
a plurality of pieces of coordinate position information for determining a covered area, an identity of a country where the cell is located, and an area identity of the covered area.

12-15. (canceled)

16. An apparatus for determining a cell configuration, comprising:
a processor; and
a memory configured to store processor-executable instructions;
wherein the processor is configured to execute:
receiving area information of at least one area covered by a cell;
receiving cell configuration information corresponding to the area information; and
determining a target area where the terminal is located and target cell configuration information corresponding to the target area based on a position where the terminal is located, the area information of the at least one area and the cell configuration information corresponding to the area information.

17. An apparatus for determining a cell configuration, comprising:
a processor; and
a memory configured to store processor-executable instructions;
wherein the processor is configured to execute the method for determining the cell configuration according to claim 8.

18. The apparatus according to claim 16, wherein the processor is further configured to execute:
determining the target area where the terminal is located based on the position where the terminal is located and the area information of the at least one area; and
determining the target cell configuration information corresponding to the target area based on the cell configuration information corresponding to the area information.

19. The apparatus according to claim 18, wherein the target cell configuration information is used to indicate whether the terminal is allowed to reside on the cell.

20. The apparatus according to claim 19, wherein the processor is further configured to execute:
determining whether to reside on the cell based on indication of the target cell configuration information corresponding to the target area; or
determining whether to reside on the cell based on the target cell configuration information corresponding to the target area and a protocol agreement.

21. The apparatus according to claim 16, wherein the cell configuration information comprises at least one of: a cell access control parameter and a cell selection parameter.

22. The apparatus according to claim 21, wherein the processor is further configured to execute:
accessing the cell based on the target cell configuration information corresponding to the target area.

23. The apparatus according to claim 16, wherein the area information comprises at least one of:
a plurality of pieces of coordinate position information for determining a covered area, an identity of a country where the cell is located, and an area identity of the covered area.

24. The apparatus according to claim 17, wherein the cell configuration information is used to indicate whether a terminal is allowed to reside on the cell, and the cell configuration information comprises at least one of: a cell access control parameter and a cell selection parameter; and
wherein the area information comprises at least one of:
a plurality of pieces of coordinate position information for determining a covered area, an identity of a country where the cell is located, and an area identity of the covered area.
